(19) United States
(12) Patent Application Publication
(10) Pub. No.: US 2017/0264113 A1
(43) Pub. Date: Sep. 14, 2017

(54) PORTABLE TERMINAL AND BATTERY CONTROL METHOD

(71) Applicant: FUJITSU LIMITED, Kawasaki-shi (JP)

(72) Inventor: Koji TAKANO, Hachioji (JP)

(73) Assignee: FUJITSU LIMITED, Kawasaki-shi (JP)

(21) Appl. No.: 15/448,452

(22) Filed: Mar. 2, 2017

(30) Foreign Application Priority Data
Mar. 11, 2016 (JP) 2016-048493

(51) Int. Cl. H02J 7/00; G05B 15/02

(52) U.S. Cl. CPC H02J 7/0024; G05B 15/02; H02J 7/0021

(57) ABSTRACT

There is provided a portable terminal including: a first battery; a second battery having a thermal capacity smaller than the first battery; a switch configured to switch an electric power supply to electronic components between the first battery and the second battery; a memory; and a processor coupled to the memory and the processor configured to control the switch so that the second battery supplies electric power to the electronic components when the portable terminal is started.

### CROSS-REFERENCE TO RELATED APPLICATION

This application is based upon and claims the benefit of priority of the prior Japanese Patent Application No. 2016-048493, filed on Mar. 11, 2016, the entire contents of which are incorporated herein by reference.

### FIELD

The embodiments discussed herein are related to a portable terminal and a control method for a battery of the portable terminal.

### BACKGROUND

A secondary battery which is generally used in a mobile terminal has a characteristic that the impedance increases at a low temperature such that the impedance at the low temperature is several times larger than the impedance at a room temperature.

That is, even when the voltages of the secondary battery at the low temperature and the room temperature are same, the voltage drop at the low temperature becomes several times larger than the voltage drop at the room temperature in the voltage supplied to a load side.

However, in the case of a terminal which is left in a power OFF state for a long time, a temperature of the terminal (terminal temperature) is almost the same as an environment temperature and there is a case in which the terminal temperature corresponds to a state at the low temperature according to the environment temperature. In the low-temperature state, when the mobile terminal is started by pressing a power key, the voltage drop occurs, and as a result, there is a possibility that the voltage may be lower than the lowest voltage required for an operation at the load side. When the voltage is lower than the lowest voltage required for the operation at the load side as described above, a system down may occur. That is, the device may not be started.

Related techniques are disclosed in, for example, Japanese Laid-Open Patent Publication No. 2010-038981, Japanese Laid-Open Patent Publication No. 2002-095182, Japanese Laid-Open Patent Publication No. 2007-148026 and Japanese Laid-Open Patent Publication No. 2012-253973.

### SUMMARY

According to an aspect of the invention, a portable terminal includes: a first battery; a second battery having a thermal capacity smaller than the first battery; a switch configured to switch an electric power supply to electronic components between the first battery and the second battery; a memory; and a processor coupled to the memory and the processor configured to control the switch so that the second battery supplies electric power to the electronic components when the portable terminal is started.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram schematically illustrating a hardware configuration of a portable terminal which is an information processing device as one example of an embodiment;

FIG. 2 is a diagram illustrating a layout of a small battery in the portable terminal as one example of an embodiment;

FIGS. 3A to 3C are diagrams each illustrating a switch of the portable terminal as one example of an embodiment;

FIG. 4 is a diagram for describing a functional configuration of the portable terminal as one example of an embodiment;

FIG. 5 is a diagram illustrating a temporal change of a required current amount when a terminal is started;

FIG. 6 is a diagram illustrating a temporal change of a battery temperature when the terminal is started;

FIG. 7 is a flowchart for describing a processing when the device is started in the portable terminal as one example of an embodiment;

FIG. 8 is a flowchart for describing a processing when the power is turned OFF in the portable terminal as one example of an embodiment; and

FIG. 9 is a flowchart for describing a charge control technique of a small battery in the portable terminal as one example of an embodiment.

### DESCRIPTION OF EMBODIMENTS

With the recent enhancement of a processing capability of a central processing unit (CPU), a required current amount in a portable terminal has increased. Further, a processing load has also increased when the portable terminal is started.

As a result, it is assumed that the voltage drop exceeds an allowed level in a low temperature environment, leading to a system down when the terminal is started, and thus, the device may not be stably started.

Hereinafter, an embodiment of a technology which may stably start the device under the low-temperature environment will be described with reference to drawings. However, embodiments disclosed below are just exemplary only and application of various modified examples or technologies which are not specified in the embodiments is not intended to be excluded. That is, various modifications of the embodiments (combinations of the embodiment and the respective modified examples, and the like) may be made within the scope without departing from the gist of the present disclosure. Further, each drawing does not intend to have only components illustrated in the drawings, but may include other functions, and the like.

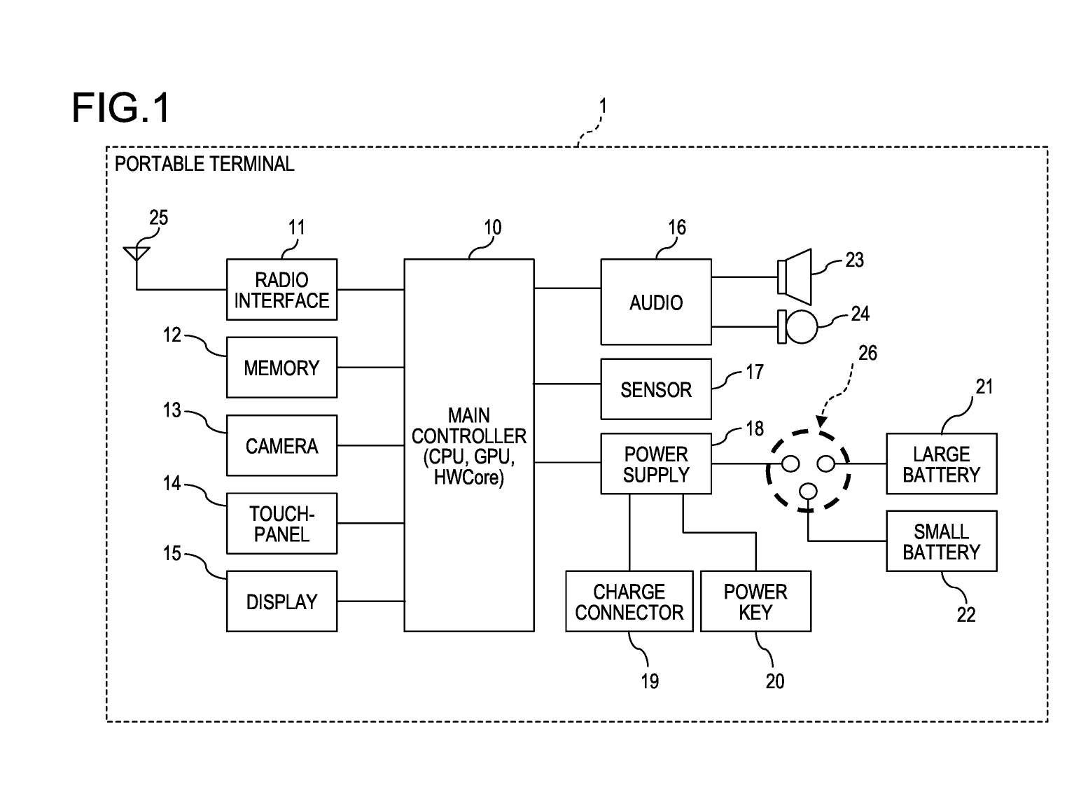

FIG. 1 is a diagram schematically illustrating a hardware configuration of a portable terminal 1 which is an information processing device as one example of an embodiment.

The portable terminal 1 is an information processing device which may be carried by a user. As illustrated in FIG. 1, the portable terminal 1 includes a main controller 10, a radio interface 11, a memory 12, a camera 13, a touch-panel 14, a display 15, an audio 16, a sensor 17, a power supply 18, a charge connector 19, a power key 20, a large battery 21, a small battery 22, a receiver/speaker 23, a microphone 24, an antenna 25, and a switch 26.

The radio interface 11 performs a wireless communication with a base station (not illustrated), and the like via the antenna 25. The camera 13 is an image pickup device for picking up a moving picture or a still image.

The display 15 is, for example, a display device such as a liquid crystal display, or the like. The touch-panel 14 is, for example, a location input device such as a touch pad. In the portable terminal 1, the touch-panel 14 is provided as a touch panel in which functions as the display 15 and the touch panel 14 are integrally implemented.

The receiver/speaker 23 is a voice output device that outputs an electric signal as a voice. The microphone 24 is a voice input device that converts the voice into the electric signal and inputs the converted electric signal.

The audio 16 controls the receiver/speaker 23 and the microphone 24 to control the input/output of a call or the voice.

The sensor 17 controls various sensors including, for example, an acceleration sensor or a temperature sensor (not illustrated).

The charge connector 19 is a connector for supplying power to the power supply 18 from the outside and is, for example, a universal serial bus (USB) connector.

The power key 20 is an input switch for inputting an indication (signal) used to start the portable terminal 1. An operator performs an input operation such as pressing the power key 20, and the like to supply the power to each unit of the portable terminal 1 from the power supply 18, and as a result, a starting process starts.

The large battery 21 and the small battery 22 are power sources that output the power and are chargeable secondary batteries (rechargeable batteries). The secondary battery is charged with a material capable of realizing a “reversible reaction” to return to an original state by applying electric energy, that is, charging the electric energy, in a discharged battery.

Two secondary batteries of the large battery 21 and the small battery 22 are provided in the portable terminal 1. The large battery 21 is one example of the first battery and the small battery 22 is one example of the second battery.

The large battery 21 supplies the power to the respective units including the main controller 10, and the like after the starting process of the portable terminal 1 is completed. The large battery 21 has a capacity to supply the power to allow the respective units such as the main controller 10, the radio interface 11, the memory 12, the camera 13, the touch-panel 14, the display 15, the audio 16, the sensor 17, the power supply 18, the charge connector 19, the power key 20, the receiver/speaker 23, the microphone 24, and the antenna 25 illustrated in FIG. 1 to stably operate while operating the portable terminal 1.

The small battery 22 has a capacity to supply a current amount (e.g., approximately 100 mAh) required for starting the portable terminal 1. The small battery 22 has a smaller physical size than the large battery 21 and a smaller thermal capacity than the large battery 21. As a result, the temperature of the small battery 22 increases more easily as compared with the temperature of the large battery 21, and as a result, the small battery 22 tends to become warm within a relatively short time. For example, even in the case where the portable terminal 1 is started under an extremely low-temperature environment, immediately after starting the device, the temperature of the small battery 22 increases to get out from a low-temperature state. That is, in the small battery 22, a decrease of impedance caused by the extremely low-temperature environment may be avoided.

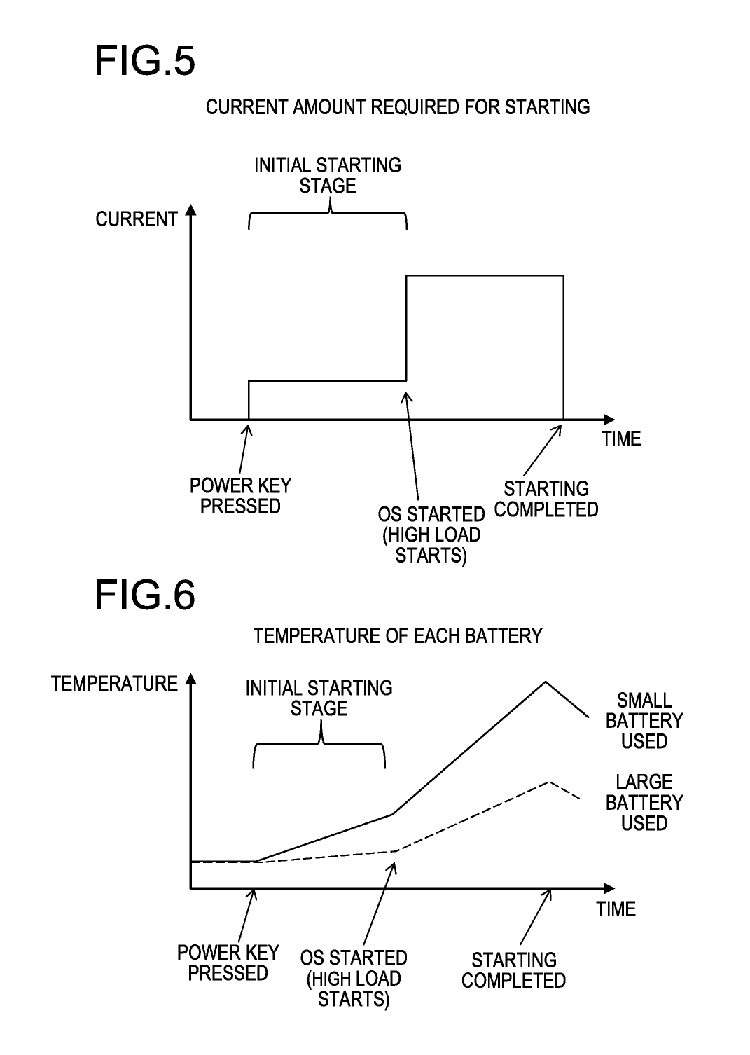

Herein, the current amount required for starting the mobile terminal such as a smart phone, or the like is generally determined by the terminal. Further, as described below using FIG. 5, there is a tendency that current pulsation becomes a low load at an initial starting stage when the device is started, that is, before an operating system (OS) is started, and becomes a high load after a middle starting stage, that is, after the OS is started.

Therefore, in the portable terminal 1, during a device starting processing period (e.g., at the initial starting stage before the OS is started and after the middle starting stage after the OS is started), the power is supplied by using the small battery 22.

Since the small battery 22 is configured to have only a power capacity to guarantee the current amount required for starting the portable terminal 1, the volume of the small battery 22 tends to be relatively small. As a result, the small battery 22 is high in terms of a degree of freedom of a layout. Therefore, in the portable terminal 1, the small battery 22 is disposed adjacent to the main controller 10 which is a heating source when the device is started.

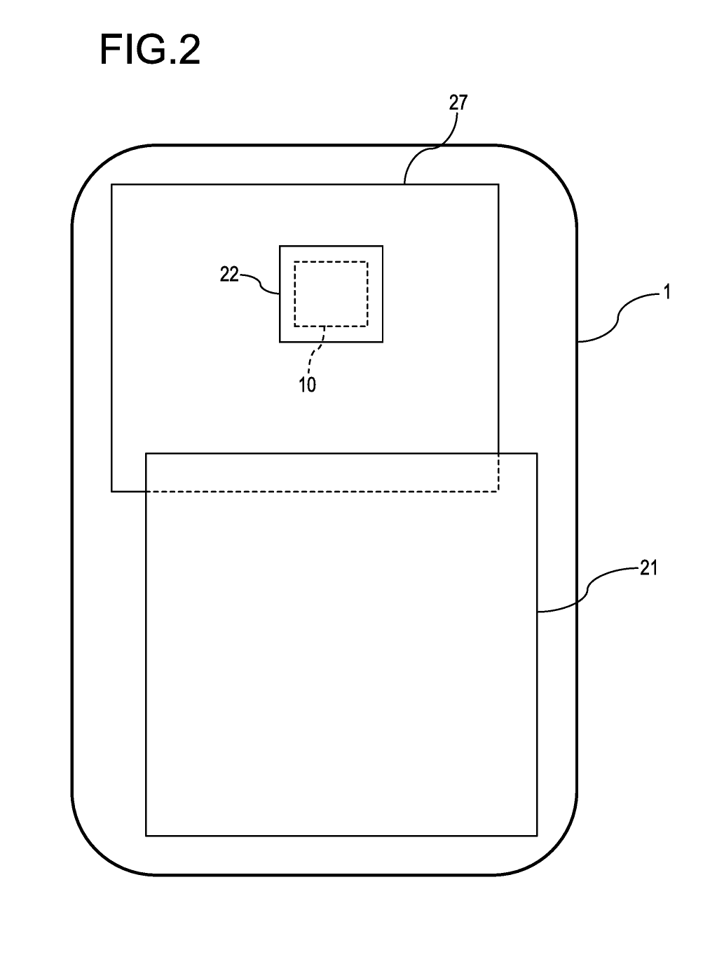

FIG. 2 is a diagram illustrating a layout of a small battery 22 in the portable terminal 1 as one example of an embodiment.

In the example illustrated in FIG. 2, only a substrate 27, the large battery 21, the small battery 22, and the main controller 10 provided in the portable terminal 1 are illustrated for the brevity of description.

In the example illustrated in FIG. 2, the large battery 21 is disposed in a lower part of the portable terminal 1 and the substrate 27 is disposed in an upper part of the portable terminal 1.

The main controller 10 is disposed on the substrate 27 and the small battery 22 is disposed adjacent to the main controller 10 so as to overlap with the main controller 10. As a result, the heat generated from the main controller 10 is conducted to the small battery 22. That is, the small battery 22 is heated by the heat generated from the main controller 10.

The power supply 18 supplies power to the respective units of the portable terminal 1 from the large battery 21 or the small battery 22. The current output from each of the large battery 21 and the small battery 22 is input to the power supply 18 and supplied to the respective units including the main controller 10, and the like, from the power supply 18.

Further, the power supply 18 performs a processing of the large battery 21 and the small battery 22. The charge connector 19 or the power key 20 is connected to the power supply 18 and the power supply 18 notifies the main controller 10 of, for example, the contents (e.g., power ON/power OFF) of the input operation that an operator performs with respect to the power key 20.

In the portable terminal 1, pressing the power key 20 means a power-ON command of the device, and pressing and holding the power key 20 for a predetermined time (e.g., 5 seconds) or more means a power-OFF command of the device.

Further, when an alternating current (AC) cable is connected to the charge connector 19 through a USB, and the like to supply the power to the charge connector 19 from the outside, the power supply 18 inputs the supplied power to the large battery 21 to charge the large battery 21.

The switch 26 switches the connections between the power supply 18 and the large battery 21 and the power supply 18 and the small battery 22, according to a control by the power controller 101 included in the main controller 10 to be described below.

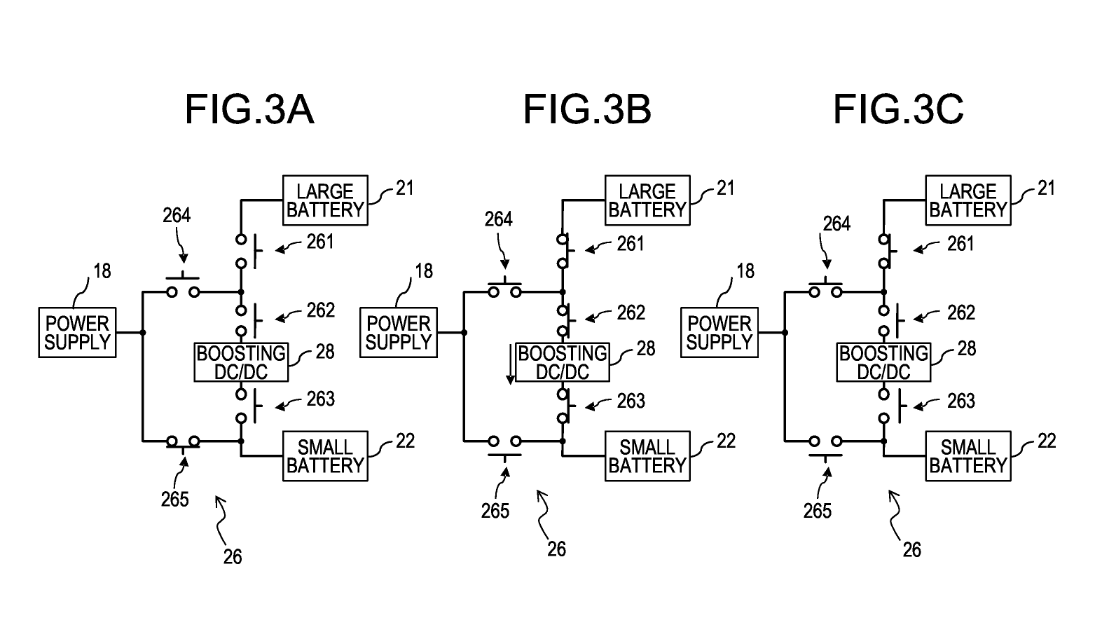

FIGS. 3A to 3C are diagrams each illustrating a switch 26 of the portable terminal 1 as one example of an embodiment.

FIG. 3A illustrates a state of the portable terminal 1 which is subjected to a starting processing. Further, FIG. 3B illustrates a state after the starting processing of the portable terminal 1 is completed, that is, when the portable terminal 1 is normally actuated, and a state in which the small battery 22 is charged. Further, FIG. 3C illustrates a state when the portable terminal is normally actuated and a state in which the small battery 22 is not charged.

As illustrated in FIGS. 3A to 3C, the switch 26 includes a plurality of switch elements 261 to 265 and is configured by combining the switch elements 261 to 265.

The switch elements 261 to 265 are, for example, field-effect transistors (FETs) and the power controller 101 included in the main controller 10 to be described below controls turning-on/off of gates of the respective switch elements 261 to 265 to switch the connections between the power supply 18, and the large battery 21 and the small battery 22.

As illustrated in FIGS. 3A to 3C, in the switch 26, the switch element 265 is disposed on a line interconnecting the power supply 18 and the small battery 22 and further, the switch element 264 and the switch element 261 are disposed in series on the line interconnecting the power supply 18 and the large battery 21.

The large battery 21 is connected to one end side of the switch element 261. Further, the power supply 18 is connected to the other end side of the switch element 261 through the switch element 264 and a boosting DC/DC converter 28 is connected to the other end side of the switch element 261 through the switch element 262.

Further, the boosting DC/DC converter 28 is also connected to the small battery 22 through the switch element 263.

That is, the boosting DC/DC converter 28 is disposed on the line interconnecting the large battery 21 and the small battery 22, and the switch element 263 is disposed on the line interconnecting the boosting DC/DC converter 28 and the small battery 22. In addition, the switch elements 261 and 262 are disposed in series on the line interconnecting the boosting DC/DC converter 28 and the large battery 21.

In the switch 26, as illustrated in FIG. 3A, only the switch element 265 is turned ON and the other switch elements 261 to 264 are turned OFF, and as a result, the small battery 22 is connected to the power supply 18. That is, the power is supplied from the small battery 22 to the respective units including the main controller 10, and the like through the power supply 18.

Hereinafter, as illustrated in FIG. 3A, a state in which the small battery 22 is connected to the power supply 18 is referred to as a first state.

Further, in the switch 26, as illustrated in FIG. 3B, only the switch element 265 is turned OFF and the other switch elements 261 to 264 are turned ON, and as a result, the large battery 21 is connected to the power supply 18. That is, the power is supplied from the large battery 21 to the respective units including the main controller 10, and the like through the power supply 18.

Further, in the state illustrated in FIG. 3B, the large battery 21 is also connected to the small battery 22 through the boosting DC/DC converter 28. As a result, the small battery 22 is charged by the power supplied from the large battery 21.

Hereinafter, as illustrated in FIG. 3B, a state in which the large battery 21 is connected to the power supply 18 and the small battery 22 is charged is referred to as a second state.

Further, in the switch 26, as illustrated in FIG. 3C, the switch elements 262, 263, and 265 are turned OFF and the switch elements 261 and 264 are turned ON, and as a result, the large battery 21 is connected to the power supply 18. That is, the power is supplied from the large battery 21 to the respective units including the main controller 10, and the like through the power supply 18.

Further, in the state illustrated in FIG. 3C, the boosting DC/DC converter 28 or the large battery 21 is not connected to the small battery 22, and as a result, the small battery 22 is not charged.

Hereinafter, as illustrated in FIG. 3C, a state in which the large battery 21 is connected to the power supply 18 and the small battery 22 is not charged is referred to as a third state.

The memory 12 is a storage memory including a read only memory (ROM) and a random access memory (RAM). A software program for realizing various functions as the portable terminal 1 or data for the program are recorded in the ROM of the memory 12. A power control program is included in the software program, which controls the power supply to the respective units constituting the portable terminal 1, such as the main controller 10, and the like.

The software program on the memory 12 is appropriately read and executed by the main controller 10. Further, the RAM of the memory 12 is used as a primary storage memory or a working memory.

The main controller 10 is a processor that controls the entirety of the portable terminal 1. The main controller 10 may be multi-processors. The main controller 10 may be, for example, any one of a CPU, a micro processing unit (MPU), a digital signal processor (DSP), an application specific integrated circuit (ASIC), a programmable logic device (PLD), and a field programmable gate array (FPGA). Further, the main controller 10 may be a combination including two or more types of elements of the CPU, the MPU, the DSP, the ASIC, the PLD, and the FPGA.

Further, the main controller 10 also has a function as a graphics processing unit (GPU) or HWCore. The HWCore is a hardware logic unit other than the CPU or the GPU in a chip. The HWCore includes, for example, a logic circuit processing an image output to the display 15, a logic circuit receiving a camera image picked up by the camera 13, a memory controller, or various input/output circuits.

Among the components provided in the portable terminal 1, the main controller 10 has large power consumption and operates by the power supplied from the large battery 21 or the small battery 22.

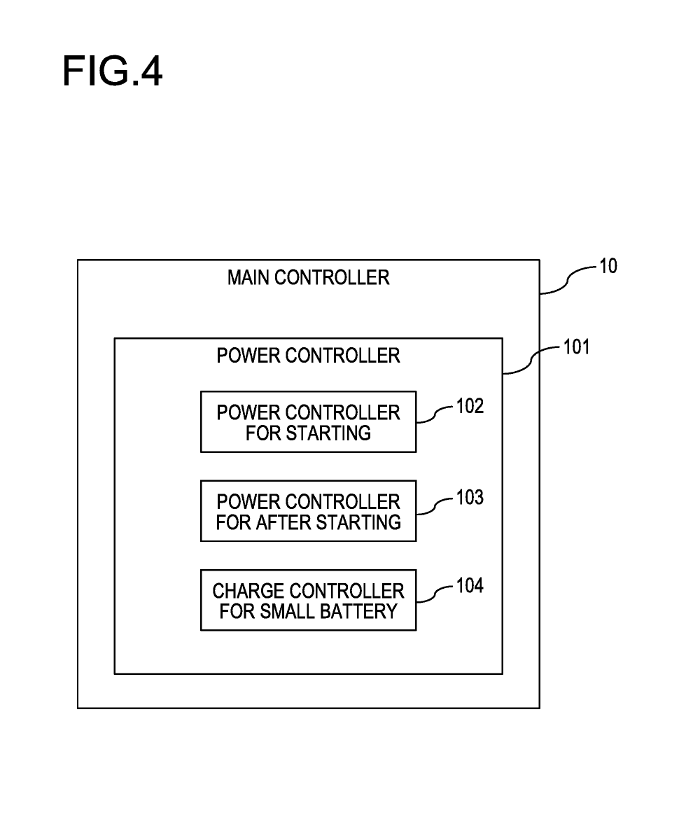

FIG. 4 is a diagram for describing a functional configuration of the portable terminal 1 as one example of an embodiment.

The main controller 10 includes the power controller 101 configured to execute a battery control program and realizes a battery control function by a power controller 102 for starting, a power controller 103 for after starting, and a small battery charge controller 104, as illustrated in FIG. 4.

Further, the battery control program is provided in a format recorded in computer readable recording media including, for example, a flexible disk, CDs (a CD-ROM, a CD-R, a CD-RW, and the like), DVDs (a DVD-ROM, a DVD-RAM, a DVD-R, a DVD+R, a DVD-RW, a DVD+RW, an HDDVD, and the like), a Blu-ray disk, a magnetic disk, an optical disk, a magneto-optic disk, and the like. In addition, a computer reads the programs from the recording media, transmits and stores the read programs to and in an internal storage device or an external storage device and uses the programs. Further, while the programs are recorded in storage devices (recording media) including, for example, the magnetic disk, the optical disk, the magneto-optical disk, and the like, the programs may be provided to the computer from the storage devices through a communication path.

When a battery control function is implemented, the programs stored in the internal storage device (e.g., the RAM or the ROM of the memory 11 in the embodiment) are executed by a microprocessor (e.g., the main controller 10 in the embodiment) of the computer. In this case, the programs recorded in the recording media may be read and executed by the computer.

The power controller 101 which controls the power supply to the main controller 10, and the like in the portable terminal 1 has functions as the power controller 102 for starting, the power controller 103 for after starting, and the small battery charge controller 104, as illustrated in FIG. 4.

The power controller 102 for starting controls a power supply state in the starting process executed when power starting causes including pressing of the power key 20, and the like occur (hereinafter, referred to as when the terminal is started) in the power off state of the portable terminal 1.

The power controller 102 for starting switches the switch 26 to connect the small battery 22 to the power supply 18 so that the power is supplied from the small battery 22 when the terminal is started. Specifically, the power controller 102 for starting sets the switch elements 261 to 265 of the switch 26 to the first state illustrated in FIG. 3A.

The power controller 102 for starting switches the switch 26 as described above, at the time of the power OFF processing of the device. As a result, during the next device starting, the power is supplied from the small battery 22.

That is, the power controller 102 for starting serves as a first controller which sets the switch 26 such that the small battery 22 becomes a power supply source for electronic components including the main controller 10, and the like in the device starting process.

FIG. 5 is a diagram illustrating a temporal change of a required current amount when a terminal is started. Further, FIG. 6 is a diagram illustrating a temporal change of a battery temperature when the terminal is started and illustrates a temperature change of each of the case where the device is started by using the small battery 22 and the case where the device is started by using a large battery having a large thermal capacity.

In general, the current amount required when the terminal is started is approximately 100 mAh and as described above, the small battery 22 of the portable terminal 1 has a configuration that has a small capacity of approximately 100 mAh.

The small-capacity small battery 22 has a small physical size. Thus, even when the small-capacity small battery 22 is started under an extremely low-temperature environment, the temperature of the battery itself increases despite the small thermal capacity of the small battery 22 just after starting the device.

As illustrated in FIG. 5, in the portable terminal 1, in an initial starting stage until the OS is started after the power key 20 is pressed, the load is small and the required current amount is small. Thereafter, after starting the OS, the load becomes high (a high load starts) and the required current amount increases.

Herein, in the case where the device is started by using the large battery having the large thermal capacity, as illustrated in FIG. 6, even when the portable terminal 1 is switched to a high-load operation, the large battery is still placed, as it is, in the low-temperature state and has large impedance. Thus, a voltage drop may occur, resulting in a system down.

In contrast, since the small battery 22 has the small thermal capacity, as illustrated in FIG. 6, the temperature increases in the low-load state in the initial starting stage. Then, when the portable terminal 1 is switched to a high-load operation, the portable terminal 1 may already get out of the low-temperature state in which the impedance is large. Accordingly, in the device starting process, the high-load operation during a period until the starting is completed after the OS starting may be stably performed by supplying the power from the small battery 22 in the state in which the impedance decreases.

The power controller 103 for after starting controls the power supply state after the starting process of the portable terminal 1 is completed and the portable terminal 1 is switched to a normal state.

As described above, in the device starting process, the power is supplied from the small battery 22 by the power controller 102 for starting.

The power controller 103 for after starting switches the switch 26 so as to supply the power from the large battery 21 and charge the small battery 22 after starting the terminal is completed. Specifically, the power controller 103 for after starting sets the switch elements 261 to 265 of the switch 26 to the second state illustrated in FIG. 3B when the device is started.

As a result, the power is supplied from the large battery 21 and the small battery 22 of which power has been consumed in the device starting process is charged. The small battery 22 is charged by inputting the power supplied from the large battery 21 into the small battery 22 through the boosting DC/DC converter 28.

That is, the power controller 102 for starting serves as the charge controller (second charge controller) that charges the small battery 22 after the device starting process performed by the supply of the power by the small battery 22 is completed.

In addition, the power controller 103 for after starting switches the switch 26 so as to supply the power from the large battery 21 without charging the small battery 22 after charging the small battery 22 is completed. Specifically, the power controller 103 for after starting sets the switch elements 261 to 265 of the switch 26 to the third state illustrated in FIG. 3C after charging the small battery 22 is completed.

As a result, the power is supplied from the large battery 21 and the small battery 22 is not charged.

That is, the power controller 103 for after starting serves as a second controller which sets the switch 26 such that the large battery 21 becomes the power supply source for the electronic components including the main controller 10, and the like after the device starting process is completed.

The small battery charge controller 104 controls charging the small battery 22. The small battery charge controller 104 charges the small battery 22 when the voltage of the small battery 22 is less than a predetermined threshold value during the normal operation.

Specifically, the small battery charge controller 104 sets the switch elements 261 to 265 of the switch 26 to the second state illustrated in FIG. 3B.

Further, the small battery 22 is charged by inputting the power supplied from the large battery 21 into the small battery 22 through the boosting DC/DC converter 28.

In the portable terminal 1, when the portable terminal 1 is placed in the power-on state, the small battery 22 is previously charged.

That is, the small battery charge controller 104 serves as the charge controller (first charge controller) that charges the small battery 22 when the voltage of the small battery 22 is less than a predetermined threshold value in a device end process.

Further, when the small battery 22 is fully charged, that is, when the voltage of the small battery 22 is equal to or more than the predetermined threshold value, charging the small battery 22 stops. In this case, the supply of the power from the large battery 21 to the main controller 10, and the like, is maintained.

Specifically, the small battery charge controller 104 returns the switch elements 261 to 265 of the switch 26 to the third state illustrated in FIG. 3C when the small battery 22 is fully charged.

Further, during charging of the small battery 22, even in the case where a power OFF operation of the portable terminal 1 is performed, the small battery charge controller 104 continuously charges the small battery 22 until charging the small battery 22 is completed.

That is, during charging of the small battery 22, in the case where the power off operation of the portable terminal 1 is performed, the small battery charge controller 104 switches the switch 26 to set the switch 26 to the third state illustrated in FIG. 3C after charging the small battery 22 is completed.

Thereafter, the power controller 102 for starting switches the switch 26 to set the switch 26 to the first state illustrated in FIG. 3A.

As a result, since the small battery 22 may be reliably fully charged when the portable terminal 1 is placed in the power-OFF state, the fully charged small battery 22 may be used as the power supply source to stably start the device.

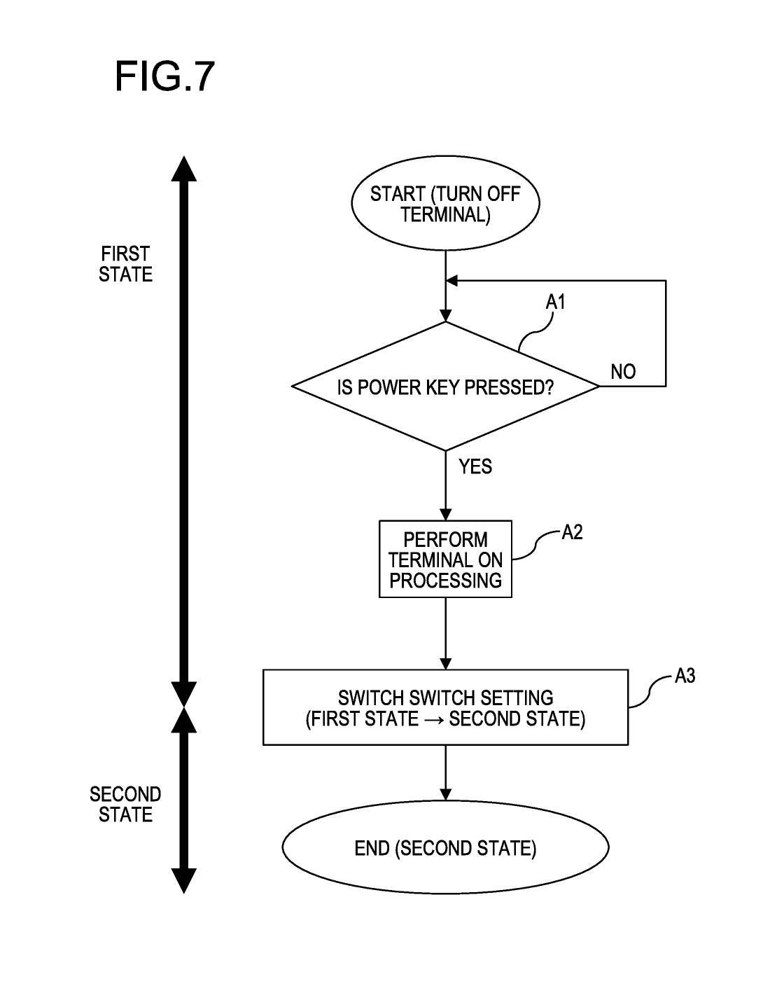

The processing in starting the device in the portable terminal 1 as one example of the embodiment configured as above will be described according to a flowchart (operations A1 to A3) illustrated in FIG. 7.

Further, in FIG. 7, the states (the first state and the third state) of the switch 26 are illustrated to correspond to the respective operations of the flowchart.

In operation A1, the power controller 102 for starting, checks whether the power key 20 is pressed. When the power key 20 is not pressed (route “NO” of operation A1), operation A1 is repeatedly performed until the power key 20 is pressed.

When the power key 20 is pressed (see route “YES” of operation A1), operation A2 is performed and the starting process of the portable terminal 1 starts. When the terminal is started, since the switch elements 261 to 265 of the switch 26 are set to the first state illustrated in FIG. 3A, the main controller 10 or the like performs the starting processing with the power supplied from the small battery 22. Up to now, the switch 26 is in the first state.

When the starting process is completed, in operation A3, the power controller 103 for after starting switches the switch 26 so as to supply the power from the large battery 21 and charge the small battery 22. That is, the power controller 103 for after starting sets the switch elements 261 to 265 of the switch 26 to the second state illustrated in FIG. 3B.

Thereafter, when charging the small battery 22 is completed and the voltage of the small battery 22 is thus equal to or more than the predetermined threshold value, the power controller 103 for after starting switches the switch 26 so as to supply the power from the large battery 21 without charging the small battery 22. That is, the power controller 103 for after starting sets the switch elements 261 to 265 of the switch 26 to the third state illustrated in FIG. 3C.

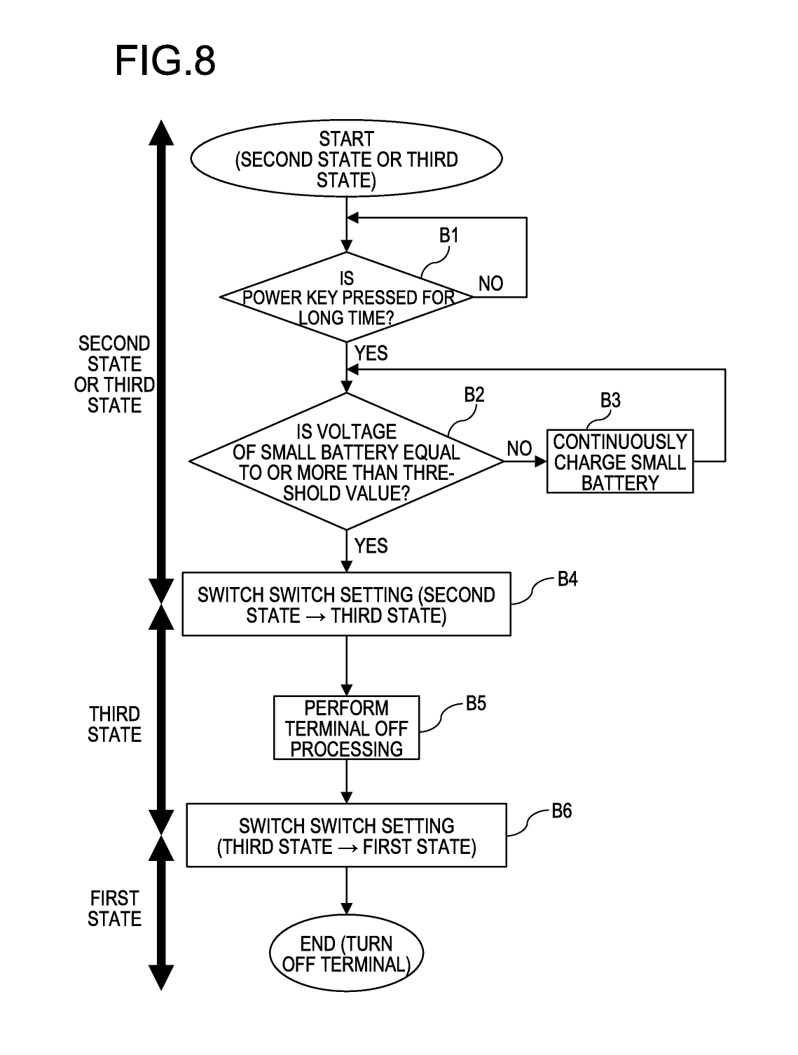

Subsequently, the processing in the power OFF state in the portable terminal 1 as one example of the embodiment will be described according to a flowchart (operations B1 to B6) illustrated in FIG. 8.

Further, in FIG. 8, the states (the first state to the third state) of the switch 26 are illustrated to correspond to the respective operations of the flowchart.

An initial state of the flowchart is the second state in which the large battery 21 is connected to the power supply 18 and the small battery 22 is charged or the third state in which the large battery 21 is connected to the power supply 18 and the small battery 22 is not charged.

In operation B1, the power controller 101 checks whether the power key 20 has been pressed for a long time. When the power key 20 has not been pressed for a long time (route “NO” of operation B1), operation B1 is repeatedly performed until the power key 20 is pressed for a long time.

When the power key 20 has been pressed for a long time (see route “YES” of operation B1), operation B2 is performed. The small battery charge controller 104 compares the voltage of the small battery 22 with the threshold value. When the voltage of the small battery 22 is less than the predetermined threshold value (see route “NO” of operation B2), the small battery charge controller 104 charges the small battery 22 in operation B3. Thereafter, the process returns to operation B2.

When the voltage of the small battery 22 is equal to or more than the predetermined threshold value (see route “YES” of operation B2), the power controller 103 for after starting sets the switch elements 261 to 265 of the switch 26 to the third state illustrated in FIG. 3C in operation B4. As a result, the third state is provided in which the power supply source is the large battery 21 and the small battery 22 is not charged.

Thereafter, in operation B5, a terminal-OFF processing by the main controller 10 is performed and in operation B6, the power controller 102 for starting sets the switch 26 to the first state illustrated in FIG. 3A. As a result, the switch 26 is switched so as to supply the power from the small battery 22.

As described above, in the terminal-OFF processing, the power controller 102 for starting sets the switch 26 to the first state to supply the power from the small battery 22 in next starting of the device. Thereafter, the processing ends.

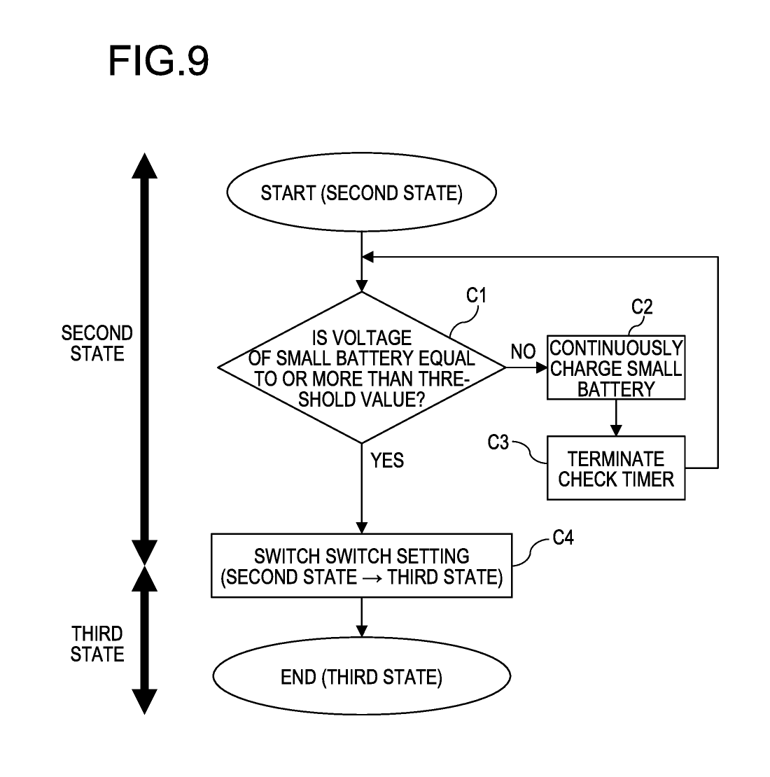

Subsequently, a charge control technique of the small battery 22 in the portable terminal 1 as one example of the embodiment will be described according to a flowchart (operations C1 to C4) illustrated in FIG. 9.

Further, in FIG. 9 as well, the states (the second state and the third state) of the switch 26 are illustrated to correspond to the respective operations of the flowchart.

In operation C1, the small battery charge controller 104 checks whether the voltage of the small battery 22 is equal to or more than the predetermined threshold value. As a result of the checking, when the voltage of the small battery 22 is less than the threshold value (see route “NO” of operation C1), the small battery charge controller 104 charges the small battery 22 in operation C2.

Thereafter, in operation C3, time measurement is performed by a timer (check timer) until a predetermined time elapses to charge the small battery 22. Thereafter, the process returns to operation C1.

When the voltage of the small battery 22 is equal to or more than the predetermined threshold value (see route “YES” of operation C1), the power controller 103 for after starting sets the switch elements 261 to 265 of the switch 26 to the third state illustrated in FIG. 3C in operation C4. As a result, the third state is provided in which the power supply source is the large battery 21 and the small battery 22 is not charged.

According to the portable terminal 1 as one example of the embodiment, two batteries of the large battery 21 and the small battery 22 having a capacity to procure a current amount (e.g., approximately 100 mAh) required for starting the terminal are provided and the power is supplied by using the small battery 22 in the device starting processing.

The small battery 22 has the small thermal capacity and the temperature of the small battery 22 increases within a short time after feeding starts, and as a result, the impedance may decrease. Therefore, the portable terminal 1 may be stably started by avoiding the large-impedance state by the low temperature.

After starting the device is completed, the power controller 103 for after starting switches the switch 26 so as to supply the power from the large battery 21. As a result, after starting the device is completed, the power is supplied to the main controller 10, and the like from the large battery 21 to stably perform the processing by the main controller 10 having the large power consumption, and the like.

Further, after starting the device is completed, the power controller 103 for after starting switches the switch 26 so as to charge the small battery 22. As a result, the power is supplied in the device starting processing to rapidly charge the small battery 22 of which the power has been consumed. The power of the small battery 22 of which the power has been consumed is rapidly restored after starting the device is completed and thereafter, when the power off operation of the device is immediately performed, a time required for the power off processing may be shortened.

The power controller 102 for starting switches the switch 26 so as to supply the power from the small battery 22 during the next device starting in the power off processing of the device. As a result, at the next device starting, the power may be certainly supplied from the small battery 22.

Further, the small battery charge controller 104 charges the small battery 22 when the voltage of the small battery 22 is less than the predetermined threshold value. Through such a configuration as well, during the next device starting, the power may be certainly supplied from the small battery 22.

Moreover, the small battery charge controller 104 checks whether the voltage of the small battery 22 is equal to or more than the predetermined threshold value during the power off processing of the device. When the voltage of the small battery 22 is less than the predetermined threshold value, the small battery charge controller 104 charges the small battery 22 and thereafter, performs the power OFF processing of the device. Through such a configuration as well, at the next device starting, the power may be certainly supplied from the small battery 22.

Further, since the small battery 22 may have only a current amount required for starting and has the small volume, the small battery 22 has a high degree of freedom of a layout. In addition, the small battery 22 is disposed adjacent to the main controller 10 so as to overlap with the main controller 10 which is the heat generation source during starting, and as a result, the heat generated from the main controller 10 is conducted to the small battery 22. That is, the small battery 22 is heated by the main controller 10. Therefore, in the small battery 22 used for starting the device, the large-impedance state by the low temperature may be avoided to stably start the portable terminal 1.

Further, during charging of the small battery 22, even in the case where a power off operation of the portable terminal 1 is performed, the small battery charge controller 104 continuously charges the small battery 22 until charging the small battery 22 is completed.

In addition, the power controller 103 for after starting sets the switch 26 to the third state after charging the small battery 22 is completed and thereafter, the power controller 102 for starting switches the switch 26 to set the switch 26 to the first state.

As a result, since the small battery 22 may be reliably and fully charged when the portable terminal 1 is placed in the power OFF state, the fully charged small battery 22 may be used as the power supply source to stably start the device.

In addition, the present invention is not limited to the embodiments, but various modifications of the present invention may be made within the scope without departing from the spirit of the present invention.

For example, in the embodiments, the small battery charge controller 104 fully charges the small battery 22 when the portable terminal 1 is in the power off state and the power controller 102 for starting controls the switch 26 to be in the first state (the state in which the device is started from the small battery 22), but the present invention is not limited thereto.

When the portable terminal is in the power OFF state, the switch 26 may be maintained as it is, for example, in the third state (the state in which the small battery 22 is not charged). In addition, when the portable terminal 1 is in the turn ON state, the environmental temperature is read by a thermistor (not illustrated) disposed around the large battery 21 in the initial starting stage having the low load and when the environmental temperature is a temperature which is equal to or less than a predetermined threshold value, the switch 26 may be switched to the first state to execute the high-load operation. As a result, the processing may speed up by simplifying the processing when the device is in the power OFF state. Further, the environmental temperature may be estimated, for example, by reading a resistance value of the thermistor.

Further, in the embodiment, the main controller 10 implements each function (e.g., the power controller 102 for starting, the power controller 103 for after starting, and the small battery charge controller 104) as the power controller 101, but the present invention is not limited thereto. For example, at least some functions of the power controller 101 may be provided outside the main controller 10, such as the outside the power supply 18, and the like.

Further, the configuration of the switch 26 is not limited to the embodiment, but may be variously modified and executed. Further, the embodiments may be executed and manufactured by those skilled in the art according to the disclosure.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to an illustrating of the superiority and inferiority of the invention. Although the embodiments of the present invention have been described in detail, it should be understood that the various changes, substitutions, and alterations could be made hereto without departing from the spirit and scope of the invention.

What is claimed is:

1. A portable terminal comprising:
a first battery;
a second battery having a thermal capacity smaller than the first battery;
a switch configured to switch an electric power supply to electronic components between the first battery and the second battery;
a memory; and
a processor coupled to the memory and the processor configured to control the switch so that the second battery supplies electric power to the electronic components when the portable terminal is started.

2. The portable terminal according to claim 1, wherein the processor controls the switch so that the second battery supplies the electric power to the electronic components when the portable terminal is switched off.

3. The portable terminal according to claim 1, wherein the processor controls the switch so that the first battery supplies the electric power to the electronic components after the portable terminal has been started.

4. The portable terminal according to claim 1, wherein the processor controls the switch so as to charge the second battery when the portable terminal is switched off and a voltage of the second battery is less than a predetermined level.

5. The portable terminal according to claim 1, wherein the second battery is arranged adjacent to a heating component mounted on the portable terminal.

6. A battery control method for a portable terminal, the battery control method comprising:
controlling a switch configured to switch an electric power supply to electronic components between a first battery and a second battery having a thermal capacity smaller than the first battery, so that the second battery supplies electric power to the electronic components when the portable terminal is started, by a processor.

7. The battery control method according claim 6, wherein the processor controls the switch so that the second battery supplies the electric power to the electronic components when the portable terminal is switched off.

8. The battery control method according claim 6, wherein the processor controls the switch so that the first battery supplies the electric power to the electronic components after the portable terminal has been started.

9. The battery control method according claim 6, wherein the processor controls the switch so as to charge the second battery when the portable terminal is switched off and a voltage of the second battery is less than a predetermined level.

10. A computer-readable non-transitory recording medium storing a program that causes a computer to execute a procedure, the procedure comprising:
controlling a switch configured to switch an electric power supply to electronic components between a first battery and a second battery having a thermal capacity smaller than the first battery, so that the second battery supplies electric power to the electronic components when the portable terminal is started, the first battery and the second battery being included in a portable terminal.

11. The computer-readable non-transitory recording medium according to claim 10, wherein the procedure controls the switch so that the second battery supplies the electric power to the electronic components when the portable terminal is switched off.

12. The computer-readable non-transitory recording medium according to claim 10, wherein the procedure controls the switch so that the first battery supplies the electric power to the electronic components after the portable terminal has been started.

13. The computer-readable non-transitory recording medium according to claim 10, wherein the procedure controls the switch so as to charge the second battery when the portable terminal is switched off and a voltage of the second battery is less than a predetermined level.
